(19) United States
(12) Patent Application Publication
(10) Pub. No.: US 2005/0038706 A1
(43) Pub. Date: Feb. 17, 2005

(54) Business transaction reporting system

(76) Inventors: Amir Yazdani, Portland, OR (US); Aaron Harsh, Portland, OR (US); Loren Clevenger, Portland, OR (US); Andrej Czapszys, Portland, OR (US); Matt Smiley, Vancouver, WA (US); Mike Johnson, Fairview, OR (US)

Correspondence Address: KOLISCH HARTWELL, P.C., 520 S.W. YAMHILL STREET, SUITE 200, PORTLAND, OR, 97204, US

(21) Appl. No.: 10/641,792

(22) Filed: Aug. 15, 2003

(51) Int. Cl. G06F 17/60

(52) U.S. Cl. 705/17

(57) ABSTRACT

An embodiment of the present invention provides a business transaction reporting system for use in tracking revenue from entertainment commodities distributed by one or more distribution parties. The distribution of the entertainment commodities is conducted through a plurality of entities that are independent from the distribution parties. In the embodiment, at least two of the entities are independent from one another. The system includes a plurality of point-of-sale (POS) computers operated at a plurality of locations. Each computer is operated by one of the independent entities and each POS computer hosts an application for recording entertainment unit transactions related to the entertainment commodities. The system further includes a central host computer system coupled to the POS computers to receive an accounting of the entertainment unit transactions, and a database configured to store, process, and report on the entertainment unit transactions.

### BACKGROUND

Motion picture studios who invest several millions of dollars in a feature film or other motion picture are eager to know the results as soon as the motion picture is released, i.e., when it begins playing in theaters. Many other parties who provide services to the studios, such as publicity planning and advertising or merchandising, also want to know the results, and all want to know as much about the results as possible, and as quickly as possible. The most important result is total ticket sales, but there would be value in knowing a breakdown of the ticket sales in as great a variety of manners as possible, such as the sales per hour, the sales in particular demographic marketing areas, and the sales at particular theaters or in particular chains. This information aids the studios, and others, including the motion pictures' distributors, the independent theaters and theater chains, and companies who will handle the motion pictures as they goes through the customary lifecycle—video outlets and retail stores, cable multi-system operators, and video-on-demand providers.

### SUMMARY

An embodiment of the present invention provides a business transaction reporting system for use in tracking revenue from entertainment commodities distributed by one or more distribution parties. The distribution of the entertainment commodities is conducted through a plurality of entities that are independent from the distribution parties. In the embodiment, at least two of the independent entities are also independent from one another. The system includes a plurality of point-of-sale (POS) computers operated at a plurality of locations. Each computer is operated by one of the independent entities and each POS computer hosts an application for recording entertainment unit transactions related to the entertainment commodities. The system further includes a central host computer system coupled to the POS computers to receive an accounting of the entertainment unit transactions, and a database configured to store, process, and report on the entertainment unit transactions.

### BRIEF DESCRIPTION OF THE DRAWING

FIG. 1 is a block diagram of an embodiment of the invention, showing the interconnections between POS computers at independent theaters, video outlets, cable MSOs, retail outlets, VOD providers, and a central host computer system, and between central transaction-reporting computers at theaters chains and the central host computer system, and also between the POS computers of individual theaters in the chains and the central computers of the chains.

### DETAILED DESCRIPTION

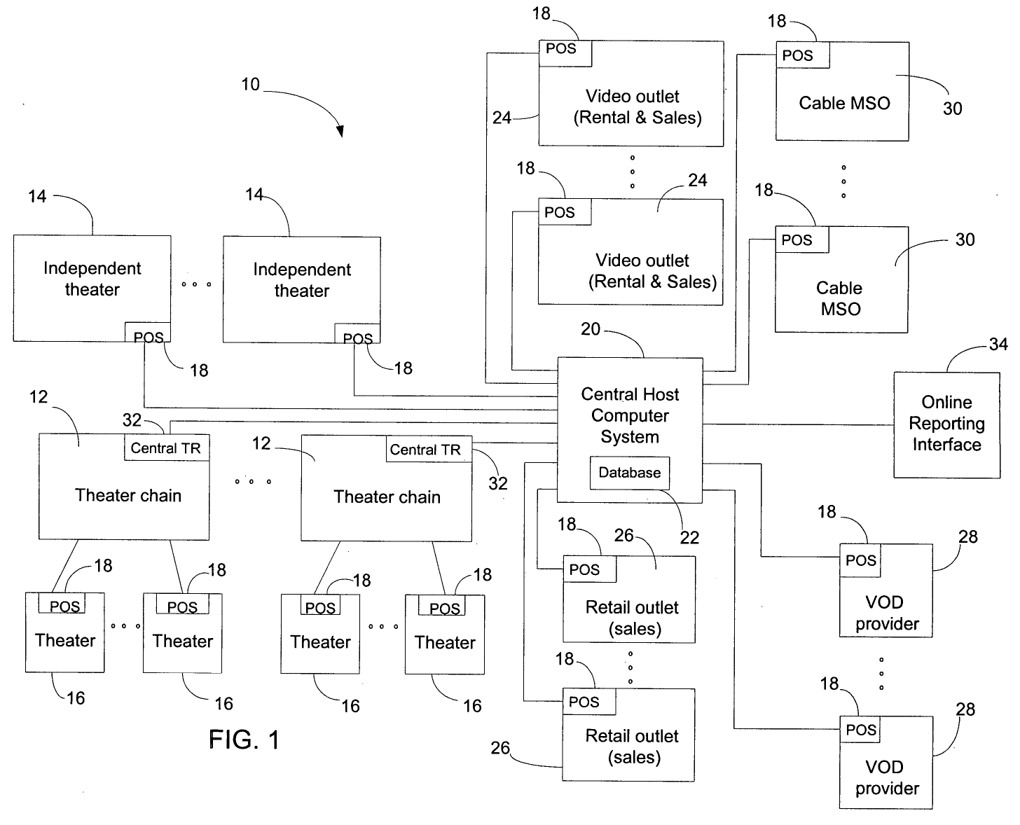

As shown in FIG. 1, an embodiment of the invention includes a business transaction reporting system, indicated generally at 10. System 10 provides for tracking revenue from an entertainment commodity, such as a feature film, or other type of motion picture, or a videogame. Typically, a motion picture is produced by a motion picture studio, which then handles distribution of the motion picture into theaters. Alternatively, the studio may contract with a distribution company to handle getting the motion picture into theaters. In either case, the motion picture is distributed for a theatrical run to entities independent from the distributing parties, typically to theater chains 12 and to independent (i.e., non-chain) theaters 14. Preferably the motion picture is distributed to several theater chains and to several independent theaters, each of which are independent from one another. Ordinarily, each theater chain 12 includes multiple individual theaters 16.

Each theater 14, 16 typically operates one or more point-of-sale (POS) computers 18, which record, for each motion picture playing in the theater, the date, time, and price of each ticket sale, and other sale parameters, such as method of payment. POS computers 18 typically are also programmed with a location for the theater, such as by zip code, which may be used to identify a demographic market area or “TV market” of the theater. POS computers 18 typically also include other information about the theater, such as name, address, chain (if applicable), etc.

Each POS computer 18 preferably is programmed with or hosts an application for recording entertainment unit transactions, such as the ticket sales, which is related to the entertainment commodities, such as the motion pictures. Each POS computer 18 typically is either a cash register or is coupled to a cash register, to coordinate a clerk's selling tickets to customers while making a record of each sale. Generally, POS computers 18 collect aggregate sales, i.e., the total dollar amount of sales for each particular motion picture over a particular time period, for reporting that out in an accounting of the sales, which accounting typically includes other desired information about the theater and motion picture. Preferably, POS computers 18 are programmed to report flash grosses, preferably on an hourly basis, which are substantially immediate reports of aggregate sales, without accounting for certain adjustments common to theaters, such as returns, which are typically adjusted later.

A central host computer system 20 is coupled to the POS computers to receive the accounting of the entertainment unit transactions, such as ticket sales. Preferably, central host 20 is operated by an entity independent from the theaters, from the motion picture studios, and from the distributors (if separate from the studios). Central host 20 is programmed with, or has access to a database 22, which is configured to store, process, and report on the entertainment unit transactions. Preferably database 20 is configured in an SQL format, but any suitable database format may be used.

Typically, business transaction reporting system 10 provides for central host 20 to receive the accounting of the entertainment unit transactions more than once per day, and preferably on an hourly basis. Other accounting periods may be used as desired.

The ordinary lifecycle of a motion picture begins with the theatrical run, the length of which generally varies, in part according to the success of the motion picture, but typically ranges from about six months to about a year. After the theatrical run, the motion picture is distributed, typically on DVDs and VHS tapes, to video outlets 24 and retail stores 26. This period, a home video period, also varies but typically lasts about 90 days. Video outlets 24 primarily provide the motion pictures to customers for short term rental, but also sell some tapes and DVDs. Examples of video outlets include the Blockbuster chain, and also small independent video stores. Retail outlets, such as Target, typically provide the tapes and DVDs for sale, but some retail outlets also provide rentals.

After the home video period, the motion pictures typically are distributed to Video-on-Demand (VOD) providers 28, for a variable period of about 60 days. Then the motion pictures typically are distributed to cable multi-system operators (MSOs) 30, who provide the motion pictures to customers in a Pay-Per-View format for about a 30-day period, and on premium cable channels for about six months. After that the motion pictures are distributed to television stations and networks.

As shown in FIG. 1, each of the video outlets, retail stores, video-on-demand providers, and cable multi-system operators preferably operates a POS computer 18 that records entertainment unit transactions, such as rental fees or sales, in a manner corollary to that for the theaters. POS computers typically are PC's running a Windows or DOS operating system. These POS computers also report an accounting of the entertainment unit transactions to central host 20, also in a manner corollary to that for the theaters. The application on the POS computers for recording and reporting the accounting is typically written in the C language.

Thus, system 10 provides for recording, tracking, and analyzing a lifecycle revenue for each motion picture. The lifecycle revenues for motion pictures may be recorded and analyzed with respect to intermediate revenues, such as in the first hour or the first three days of the theatrical run, to create a predictive model for lifecycle revenues for motion pictures. For example, based on the predictive model, database 22 may be configured to facilitate a prediction of a lifecycle revenue for a motion picture based on entertainment unit transactions in a first hour after the motion picture is released.

System 10, particularly the video outlets and retail outlets, may be used to report on video game sales and video game rentals. Database 22 may be configured to store, process, and report on such sales and rentals similar to the reporting for the motion pictures.

Typically within each theater chain, POS computers 18 of individual theaters 16 are coupled to a central transaction-reporting (TR) computer 32. Preferably, central TR computers 32 provide an accounting for ticket sales in a manner similar to POS computers 18, and additionally including a break down of the entertainment unit transactions by individual theaters within each chain.

Preferably, POS computers 18 and central TR computers 32 transmit the accounting of the entertainment unit transactions in a common format. The typical format are ftp, uucp, dial-up modem, and automated fax, and other formats may be used as desired.

Central host 20 provides for an online reporting interface 34 to database 22, and preferably database 22 provides for a drill down capability, whereby a user of interface 34 may select by clicking on an item displayed in interface 34, and thereby obtain more specific information about the item. This drill-down capability preferably is provided in several layers so that the user may drill down through several screens of interface 34, accessing different information at each layer.

Preferably database 20 also includes a calendar of various processes, such as school schedules and major event timing. Preferably database 20 also reports to online interface 34 with a total for flash grosses for each motion picture screening on a weekend. Typically this reporting of weekend flash grosses includes a report of the number of locations where the motion picture is screening and a report of the number of those locations where POS computers 18 are accounting for the entertainment unit transactions.

Online interface 34 typically is programmed to require user ids and passwords, or other security measures, whereby the reporting of weekend flash grosses may selectively be restricted to one or more users associated with a theater chain. Furthermore, online interface 34 may be programmed to selectively restrict weekend flash grosses to one or more users at an individual theater. Additionally, online interface 34 may be programmed to selectively restrict reporting of weekend flash grosses to a demographic marketing area. Alternatively, such restrictive programming may be incorporated into database 22.

In operation, a method for implementing business transaction reporting system 10 in a distribution chain that includes plural distributed points of sale with each point of sale including one or more POS computers 18 storing information about the point of sale, typically will include programming each POS computer 18 with an application for recording entertainment unit transactions, coupling central host 20 to the POS computers, configuring the central host computer system to receive an accounting of the entertainment unit transactions from the POS computers, and providing database 20, which is configured to store, process, and report on the entertainment unit transactions.

Database 20 and online interface 34 may be programmed to report a series of predictions for lifecycle revenue for each motion picture. Such predictions for lifecycle revenue may be based on theater ticket sales, motion picture VHS sales, motion picture DVD sales, motion picture VHS rentals, and/or motion picture DVD rentals. Such predictions may be provided in a business projection method wherein database 22 receives a gross transactions report, such as flash grosses, within an initial period, such as one hour, starting at an initial release of a new motion picture. The database 22 and online interface 34 may then provide a report of predicted transactions for the motion picture based on the transactions report from the initial period. Preferably the report of predicted transactions for the motion picture covers both the total lifecycle and intermediate periods, such as the first three days, which is typically the first weekend, of ticket sales for the motion picture.

Database 22 provides for recording lifecycle revenues, including tracking revenues at various points in the lifecycle, and thus database 22 may be used to provide the predictive model noted above. For example, the database may be set up to receive from the POS computers 18 a gross transactions report within an initial period of more than about four hours starting from an initial release of the motion picture, a transactions report for a first three days after release of the motion picture, a transactions report for a theatrical run of the motion picture, a transactions report for a home video phase of the motion picture, a transactions report for a VOD phase of the motion picture, and a transactions report for a PPV phase of the motion picture.

Thus, the predictive model may be used for a new motion picture, or other product, such as a videogame, to predict as each point in the lifecycle is reached, expected revenues for each of several future points in the lifecycle. In addition to the above noted one-hour and three-day periods, other points may include two hours, four hours or any other length. Similarly the predictions may be made for revenues through the theatrical run, the home video phase, the VOD phase, the PPV phase, and subsequent phases, such as premium cable and TV. Preferably the revenue prediction for each point is based on one or more of the earlier revenue results for the motion picture. Typically, user ids and passwords are used as noted above, so that, for each motion picture made by a particular motion picture studio, access to fill information in the transactions reports is restricted to the motion picture studio and/or to a subset of users within the studio. Database 22 and online interface 34 may be further programmed to provide, for a second motion picture studio that did not make the motion picture, access only to limited information in the transactions reports on the motion picture.

Database 20 preferably is programmed with information for each independent theater and each individual theater in each chain. The information typically includes the demographics of the customers at the theater. Preferably, the demographic information includes categories including gender, age, ethnicity, income, and house value. Online interface 34 is preferably programmed to provide reports on any motion picture where the information is selected for particular demographics.

While the present disclosure has been made with reference to the foregoing preferred embodiments, those skilled in the art will understand that many variations may be made therein without departing from the spirit and scope defined in the following claims. The disclosure should be understood to include all novel and non-obvious combinations of elements described herein, and claims may be presented in this or a later application to any novel and non-obvious combination of these elements.

1. A business transaction reporting system for use in tracking revenue from entertainment commodities distributed by one or more distribution parties through a plurality of entities independent from the distribution parties, and wherein at least two of the plurality of entities are independent from one another, the system comprising:
a plurality of point-of-sale (POS) computers operated at a plurality of locations, each computer operated by one of the independent entities, each POS computer hosting an application for recording entertainment unit transactions related to the entertainment commodities;
a central host computer system coupled to the POS computers to receive an accounting of the entertainment unit transactions; and
a database configured to store, process, and report on the entertainment unit transactions.

2. The business transaction reporting system of claim 1 wherein the central host computer system receives the accounting of the entertainment unit transactions more than once per day.

3. The business transaction reporting system of claim 1 wherein the central host computer system receives the accounting of the entertainment unit transactions on an hourly basis.

4. The business transaction reporting system of claim 1 wherein the locations of the POS computers are selected from the group of theatrical box offices, theater chains, video outlets, cable multi-system operators, video-on-demand providers, and retail stores.

5. The business transaction reporting system of claim 1 wherein the entertainment unit transactions include ticket sales for theatrical showings of a motion picture.

6. The business transaction reporting system of claim 5 wherein the database is configured to facilitate a prediction of a lifecycle revenue for the motion picture based on entertainment unit transactions in a first hour after the motion picture is released.

7. The business transaction reporting system of claim 1 wherein the entertainment unit transactions include one or more transactions selected from the group of motion picture theater ticket sales, motion picture VHS sales, motion picture DVD sales, motion picture VHS rentals, motion picture DVD rentals, video game sales, and video game rentals.

8. The business transaction reporting system of claim 1 wherein the accounting of entertainment unit transactions includes flash grosses.

9. The business transaction reporting system of claim 1 wherein at least one POS computer is a central computer of a theater chain.

10. The business transaction reporting system of claim 9 wherein the accounting provided by the theater chain computer breaks down the entertainment unit transactions by individual theaters within each chain

11. The business transaction reporting system of claim 1 wherein the POS computers transmit the accounting of the entertainment unit transactions in a format selected from the group of ftp, uucp, dial-up modem, and automated fax.

12. The business transaction reporting system of claim 1 wherein the database provides a drill down capability.

13. The business transaction reporting system of claim 1 wherein the database includes a calendar of school schedules.

14. The business transaction reporting system of claim 1 wherein the database includes a calendar of major event timing.

15. The business transaction reporting system of claim 1 wherein the database reports for a plurality of currently-screening motion pictures a total for flash grosses for each motion picture for a weekend.

16. The business transaction reporting system of claim 15 wherein the reporting of weekend flash grosses includes a report of the number of locations where the motion picture is screening and a report of the number of those locations where the POS computers are accounting for the entertainment unit transactions.

17. The business transaction reporting system of claim 15 wherein the reporting of weekend flash grosses may selectively be restricted to a theater chain.

18. The business transaction reporting system of claim 15 wherein the reporting of weekend flash grosses may selectively be restricted to an individual theater.

19. The business transaction reporting system of claim 15 wherein the reporting of weekend flash grosses may selectively be restricted to a demographic marketing area.

20. The business transaction reporting system of claim 1 wherein the database reports for a plurality of currently-screening motion pictures a plurality of totals for flash grosses on an hourly basis.

21. A business transaction reporting method for use in a distribution chain that includes plural distributed points of sale, each point of sale (POS) including a POS computer storing information about the point of sale, the method comprising the steps of:
programming each POS computer with an application for recording entertainment unit transactions;
coupling a central host computer system to the POS computers, the central host computer system configured to receive an accounting of the entertainment unit transactions; and
providing a database configured to store, process, and report on the entertainment unit transactions.

22. The business transaction reporting method of claim 21 wherein the application on each POS computer provides for transmitting the accounting of the entertainment unit transactions on an hourly basis.

23. The business transaction reporting method of claim 21 wherein the entertainment unit transactions include theatrical ticket sales for a motion picture.

24. The business transaction reporting method of claim 23 wherein the database reports a predicted lifecycle revenue for the motion picture based on theatrical ticket sales in a first hour after the motion picture is released.

25. The business transaction reporting method of claim 23 wherein the database reports a series of predictions for lifecycle revenue.

26. The business transaction reporting method of claim 25 wherein the predictions for lifecycle revenue are based on one or more categories of entertainment unit transactions selected from the group of motion picture theater ticket sales, motion picture VHS sales, motion picture DVD sales, motion picture VHS rentals, motion picture DVD rentals.

27. The business transaction reporting method of claim 21 for use in the distribution chain wherein the distributed points of sale includes at least one box office at an independent theater, and wherein the POS computer at the independent theater is coupled to the central host computer.

28. The business transaction reporting method of claim 21 further including the step of providing the database with a drill down capability.

29. The business transaction reporting method of claim 21 further including the step of providing the database with a calendar of school schedules and major event timing.

30. The business transaction reporting method of claim 21 wherein the database reports for a plurality of currently-screening motion pictures a plurality of totals for flash grosses on an hourly basis.

31. A theatrical box office reporting system for reporting ticket sales from independent theaters and chains of theaters, each independent theater including one or more point-of-sale (POS) computers, each POS computer at the independent theaters hosting an application for recording ticket sales, and each chain of theaters including a central computer for recording ticket sales at points of sales within the chain, the reporting system comprising:
a central host computer system coupled to the POS computers of the independent theaters and to the central computers of the chains to receive from each computer an accounting of the entertainment unit transactions; and
a database configured to store, process, and report on the entertainment unit transactions.

32. The theatrical box office reporting system of claim 31 wherein the central host computer system receives the accounting of the ticket sales on an hourly basis.

33. The theatrical box office reporting system of claim 31 wherein the database is configured to provide a prediction of a lifecycle revenue for a motion picture based on ticket sales in a first hour after the motion picture is released.

34. The theatrical box office reporting system of claim 31 wherein the accounting of ticket sales includes flash grosses.

35. The theatrical box office reporting system of claim 31 wherein the POS computers at the independent theaters transmit the accounting of the ticket sales in a format selected from the group of ftp, uucp, dial-up modem, and automated fax.

36. The theatrical box office reporting system of claim 31 wherein the database provides a drill down capability.

37. The theatrical box office reporting system of claim 31 wherein the database reports for a plurality of currently-screening motion pictures a total for flash grosses for each motion picture for a weekend.

38. The theatrical box office reporting system of claim 31 wherein the reporting of ticket sales may selectively be restricted to a theater chain.

39. The theatrical box office reporting system of claim 31 wherein the reporting of ticket sales may selectively be restricted to an independent theater.

40. The theatrical box office reporting system of claim 31 wherein the database includes, for each independent theater and each individual theater in each chain, information about the demographics of the customers at the theater, the demographic information including one or more categories selected from the group of gender, age, ethnicity, income, and house value.

41. A business projection method comprising the steps of:
receiving a gross transactions report within an initial period starting at an initial release of a new product,
providing a report of predicted transactions for the new product based on the transactions report from the initial period.

42. The business projection method of claim 41 wherein the report of predicted transactions for the new product covers a lifecycle for the product.

43. The business projection method of claim 41 wherein the report of predicted transactions for the new product covers a first three days of transactions for the product.

44. The business projection method of claim 41 wherein the initial period is about two hours.

45. The business projection method of claim 41 wherein the new product is a motion picture.

46. The business projection method of claim 45 further including the steps of receiving a transactions report for a first three days after release of the motion picture, and providing a prediction of transactions during a theatrical run of the motion picture.

47. The business projection method of claim 46 wherein the prediction of transactions for the theatrical run uses at least one of the gross transactions report from the initial period and the transactions report from the first three days.

48. The business projection method of claim 46 further including the steps of receiving a transactions report for the theatrical run of the motion picture, and providing a prediction of transactions during a home video phase for the motion picture.

49. The business projection method of claim 48, wherein the prediction of transactions for the home video phase uses at least one of the gross transactions report from the initial period, the transactions report from the first three days, and the transactions report from the theatrical run.

50. The business projection method of claim 48 further including the steps of receiving a transactions report for the home video phase of the motion picture, and providing a prediction of transactions during a video-on-demand (VOD) phase for the motion picture.

51. The business projection method of claim 50, wherein the prediction of transactions for the VOD phase uses at least one of the gross transactions report from the initial period, the transactions report from the first three days, the transactions report from the theatrical run, and the transactions report from the home video phase.

52. The business projection method of claim 50 further including the steps of receiving a transactions report for the VOD phase of the motion picture, and providing a prediction of transactions during a pay-per-view (PPV) phase for the motion picture.

53. The business projection method of claim 52, wherein the prediction of transactions for the VOD phase uses at least one of the gross transactions report from the initial period, the transactions report from the first three days, the transactions report from the theatrical run, the transactions report from the home video phase, and the transactions report from the VOD phase.

54. A method for providing on an hourly basis theatrical box office reports for a motion picture, wherein the motion picture is screening at one or more theaters including one or more point of sale (POS) computers for storing information about ticket sales at each theater, the method comprising the steps of:
programming each POS computer with an application for recording ticket sales for each hour after release of the motion picture;
coupling a central host computer system to the POS computers, the central host computer system configured to receive an accounting of the ticket sales for each hour; and
providing a database configured to store, process, and report on the ticket sales for each hour.

55. The method of claim 54 for use with the one or more POS computers wherein at least one of the POS computers is a central computer of a chain of theaters.

56. The method of claim 54 wherein the database is configured to provide a prediction of a lifecycle revenue for the motion picture based on the ticket sales in a first hour after the motion picture is released.

57. The method of claim 54 wherein the locations for the POS computers includes at least one box office at an independent theater.

58. The method of claim 54 wherein the accounting of entertainment unit transactions includes flash grosses.

59. The method of claim 54 wherein the POS computers transmit the accounting of the entertainment unit transactions in a format selected from the group of ftp, uucp, dial-up modem, and automated fax.

60. The method of claim 54 further including the step of providing the database with a drill down capability.

61. The method of claim 54 wherein the database's reporting of ticket sales may selectively be restricted to a theater chain.

62. The method of claim 54 wherein the database's reporting of ticket sales may selectively be restricted to an individual theater.

63. The method of claim 54 wherein the database's reporting of ticket sales may selectively be restricted to a demographic marketing area.

64. The method of claim 54 further including the step of providing the database with a calendar of school schedules and major event timing.

65. The method of claim 54 wherein the database includes, for each theater, information about the demographics of the customers at the theater, the demographic information including one or more categories selected from the group of gender, age, ethnicity, income, and house value.

66. A method for lifecycle tracking and reporting of entertainment unit transactions for a motion picture, the method comprising the steps of:
setting up a database to receive: a gross transactions report within an initial period of more than about four hours starting from an initial release of the motion picture,
a transactions report for a first three days after release of the motion picture,
a transactions report for a theatrical run of the motion picture,
a transactions report for a home video phase of the motion picture,
a transactions report for a VOD phase of the motion picture, and
a transactions report for a PPV phase of the motion picture.

67. The method of claim 66 further including the step of providing a report of predicted transactions for the motion picture.

68. The method of claim 67 wherein the report of predicted transactions for the motion picture covers a period selected from the group of a lifecycle for the motion picture, a first three days of transactions after release of the motion picture, a theatrical run of the motion picture, a home video phase for the motion picture, a VOD phase for the motion picture, and a PPV phase for the motion picture.

69. The method of claim 66 further including the step of providing password-protected access to the database, whereby for each motion picture made by a motion picture studio, access to full information in the transactions reports is restricted to the motion picture studio.

70. The method of claim 69 wherein the access to full information in the transactions report in the motion picture studio is further restricted to a subset of users within the studio.

71. The method of claim 69 wherein a second motion picture studio that did not make the motion picture is permitted access only to limited information in the transactions reports on the motion picture.
